(19) United States
(12) Patent Application Publication
(10) Pub. No.: US 2013/0114176 A1
(43) Pub. Date: May 9, 2013

(54) PROTECTION DEVICE TO BE ASSOCIATED IN AN ELECTRICAL CIRCUIT WITH A CURRENT-BREAKER DEVICE OF INCREASED SERVICE LIFE

(71) Applicant: Jean Marmonier, Saint Aunes (FR)

(72) Inventor: Jean Marmonier, Saint Aunes (FR)

(73) Assignees: SCHNEIDER ELECTRIC PROTECTION & CONTROLE SA, Lattes (FR); ALSTOM TECHNOLOGY LTD., Baden (CH)

(21) Appl. No.: 13/695,464

(22) PCT Filed: May 10, 2011
(86) PCT No.: PCT/EP11/57544

§ 371 Date: Jan. 3, 2013

(30) Foreign Application Priority Data
May 11, 2010 (FR) 10 53659

(51) Int. Cl. H02H 3/093

(52) U.S. Cl. 361/87

(57) ABSTRACT

A protection device is to be associated in an electrical circuit (3) with a current-breaker device (20) including at least one pair (2) of contacts. The protection device includes a measuring device (1.1) for detecting a fault in the electrical circuit, at least one pair (6) of trigger contacts adapted to assume a closed or open position and to energize a coil for operating the pair (2) of contacts of the current-breaker device (20), and a control device (1.2) for commanding closing the pair (6) of trigger contacts in the event of detecting a fault, launching a time-delay and opening the pair of trigger contacts in the event of disappearance of the fault at the end of the time-delay, and barring opening pending operator intervention if the fault persists at the end of the time-delay.

### TECHNICAL FIELD

The present invention relates to the field of devices for protecting electrical circuits and more precisely protection devices associated with current-breaker devices of the circuit-breaker or switch type used to protect electrical circuits, for example medium-voltage, high-voltage, and very-high-voltage electrical networks.

### PRIOR ART

FIG. 1 shows a conventional arrangement of a device 1 for protecting a current-breaker device 20 adapted to break an electrical circuit 3. The current-breaker device 20 may be a circuit-breaker or a switch, for example, and may include at least one pair 2 of contacts 2.1, 2.2 that are movable relative to each other. In the context of this invention, a contact is a part that, when it touches another part, allows a current to flow from one to the other. These two contacts form a pair of contacts.

This pair 2 of contacts is able to assume an open position or a closed position. In FIG. 2A, the pair 2 of contacts are seen in the closed position (on the left) and then in the open position (on the right). The pair 2 of contacts of the current-breaker device 20 are mechanically coupled to a pair 4 of signaling contacts 4.1, 4.2 that represent the position of the pair 2 of contacts of the current-breaker device 20. The pair 4 of signaling contacts may assume an open position or a closed position. The position of this pair 4 of signaling contacts is the image of the position of the pair 2 of contacts of the current-breaker device 20.

The electrical circuit 3 may be a power transformer or a medium-voltage, high-voltage, or very-high-voltage line, for example, such as an overhead or underground line or a cable connection of some other type. A trigger coil 5 is connected in series with the pair 4 of signaling contacts. This trigger coil 5 operates in a similar way to the coil of an electromagnet; it releases a member, for example a very powerful spring (not shown), that leading to opening of the pair 2 of contacts of the current-breaker device 20.

The protection device 1 includes a device 1.1 for measuring the current and/or voltage delivered by the secondaries of current and voltage transformers in the electrical circuit 3, not shown and referred to as measurement transformers, plus at least one pair 6 of trigger contacts 6.1, 6.2 and a device 1.2 for commanding operation of the pair 6 of trigger contacts as a function of the measured values. The control device 1.2 may include an electromagnet-type element (not shown); it holds the pair 6 of trigger contacts in the open position in the absence of a fault and in the closed position if a fault is detected. This pair 6 of trigger contacts is connected in series with the pair 4 of signaling contacts 4.1, 4.2 and the trigger coil 5. Thus in the absence of a fault the trigger coil 5 is not energized, because it is not supplied with current. In the absence of fault in the electrical circuit 3, the pair 2 of contacts of the current-breaker device 20 are in the closed position, as are the pair 4 of signaling contacts.

FIG. 2A is in the form of a timing diagram relating to satisfactory operation of the current-breaker device 20, and it shows the positions assumed by the pair 6 of trigger contacts 6.1, 6.2, the pair 2 of contacts 2.1, 2.2 of the current-breaker device 20, and the pair 4 of signaling contacts 4.1, 4.2 when a fault occurs in the electrical circuit 3. The fault leads to a modification of the current flowing in the electrical circuit and consequently of the signal transmitted by the measurement transformer to the measurement device 1.1. The shape of the current and the voltage in the electrical circuit in the measurement device is indicated. At time t0, a fault occurs in the electrical circuit downstream of the current-breaker device 20. A fault current appears but is not yet detected by the measurement device 1.1 of the protection device 1. At time t1, the measurement device 1.1 of the protection device 1 detects a fault current. The control device 1.2 is activated and at time t2 the pair 6 of contacts 6.1, 6.2 of the protection device 1 are closed. The trigger coil 5 is supplied with current. The order to open the pair 2 of contacts 2.1, 2.2 of the current-breaker device 20 is issued. At time t3, the pair 2 of contacts 2.1, 2.2 of the current-breaker device 20 are opened and also the pair 4 of signaling contacts 4.1, 4.2. These openings may be simultaneous or slightly offset in time. The opening of the pair 4 of signaling contacts 4.1, 4.2 breaks the energization current flowing in the trigger coil 5. The signaling contacts 4.1, 4.2 are rated for this purpose, i.e. to withstand the electrical arc that inevitably appears on opening the contacts when current is flowing in the trigger coil 5.

At time t4 the fault has disappeared, and because the pair 2 of contacts of the current-breaker device 20 are in the open position, the current flowing in the electrical circuit 3 is broken.

At time t5, the measurement device 1.1 of the protection device 1 detects that the current has been broken in the electrical circuit 3 and the control device 1.2 commands opening of the pair 6 of trigger contacts of the protection device 1. At time t6, the pair 6 of trigger contacts of the protection device 1 open. The notation dt1 denotes the triggering time of the protection device 1, i.e. the time between the time t0 of appearance of the fault and the time t2 of closing the pair 6 of trigger contacts of the protection device 1. The notation dt2 denotes the off-delay time of the trigger contacts 6.1, 6.2 of the pair 6 of trigger contacts, i.e. the time between the time t4 of the fault disappearing and the time t6 of the pair 6 of trigger contacts of the protection device opening.

The situation in FIG. 2B is that the current-breaker device 20 is faulty, the pair 2 of contacts failing to open to break the current in the electrical circuit 3.

The sequence of operations is identical to that described above between times t0 and t2. The pair 2 of contacts of the current-breaker device 20 are not opened or not opened sufficiently at time t3 since the current-breaker device 20 is inoperative. In this situation, the fault is eliminated at time t3 by opening the contacts of another current-breaker device (not shown) upstream of the faulty current-breaker device 20.

The pair of contacts of this upstream current-breaker device are opened after an upstream protection device associated with them has detected the fault and commanded opening, as described with reference to FIG. 2A. The current in the electrical circuit 3 is therefore broken. In particular, as described in document EP 0 820 081, a time-delay may be set up on the trigger coil 5 and/or the signaling contacts 4 in order to accelerate the detection of the circuit-breaker failure and to actuate the upstream protection device (not shown).

At time t4, the measurement device 1.1 of the protection device 1 detects that the current in the electrical circuit 3 has been broken and commands the opening of the pair 6 of trigger contacts of the protection device 1. The time interval between times t1 and t4 is of the order of 300 milliseconds (ms) to 500 ms, for example. At time t5, the pair 6 of trigger contacts of the protection device are opened. However, the pair 4 of signaling contacts have not been opened because they are mechanically coupled to the pair 2 of contacts of the current-breaker device 20, which in this situation is faulty. Current therefore flows in the trigger coil 5. The contacts 6.1, 6.2 of the pair 6 of trigger contacts must therefore break this current when they are opened. The current flowing in the trigger coil 5 is generally greater than the break capacity of the contacts 6.1, 6.2 of the pair 6 of trigger contacts. On breaking this current, the contacts 6.1, 6.2 of the pair 6 of trigger contacts will be damaged. It is of course possible to replace them each time they are damaged after failure of the contacts 2.1, 2.2 of the current-breaker device 20 to open. That solution is costly since it requires a specific maintenance operation. Moreover, if the operator fails to replace the pair of trigger contacts, there is a very high risk of the pair of trigger contacts not closing in the event of a new fault.

FIG. 2C is a flowchart relating to operation as described above. The first block 101 represents detection of the presence of a fault in the electrical circuit by the measurement device of the protection device. If there is no fault nothing happens and surveillance continues until a fault appears. If a fault is detected, closure of the pair of trigger contacts of the protection device is commanded (block 102). The protection device continues to detect the fault in the block 103 and the closure of the pair of trigger contacts (block 102) is maintained as long as the fault persists. If the measurement device no longer detects any fault but the current-breaker device is faulty, the pair of trigger contacts are opened (block 104). This is when the trigger contacts are damaged.

This problem of damaging the trigger contacts 6.1, 6.2 can be solved by further providing in the protection device 1 an intermediate relay 7 having a coil 7.3 in series with the contacts 6.1, 6.2 of the pair 6 of trigger contacts and at least one pair of contacts 7.1, 7.2 connected in series with the pair 4 of signaling contacts and the trigger coil 5 (see FIG. 3A). This intermediate relay 7 is chosen to have a much higher breaking capacity than the trigger contacts 6.1, 6.2 and that is sufficient to break the current flowing in the trigger coil 5. If the contacts 2.1, 2.2 of the pair 2 of contacts of the current-breaker device 20 do not open on the appearance of a fault current, it is the contacts 7.1, 7.2 of the relay 7 in the open position that break the current flowing in the trigger coil 5, since the signaling contacts 4.1, 4.2 are not open because of the faulty current-breaker device 20. This prevents damaging the trigger contacts 6.1, 6.2 of the protection device 1. However, this configuration has several drawbacks. Firstly it is costly, such relays being costly components. Another drawback, linked to the fact that components are added, is that the reliability of the triggering circuit, comprising the trigger coil 5, the pair 6 of trigger contacts, the intermediate relay 7, and the pair 4 of signaling contacts, is degraded. A further drawback is that the triggering delay is increased because of the response time of the intermediate relay. When the coil of the relay is energized, it actuates the contacts of the pair 6 of contacts to close them only after a predefined time that may be as much as a few milliseconds.

Another known solution is to introduce into the protection device 1 a surveillance device 8 for monitoring the current feeding the trigger coil 5 (see FIG. 3B). As soon as the fault has disappeared, meaning that the pair 6 of trigger contacts should be open even though the pair 4 of signaling contacts are closed, the surveillance device 8 verifies whether current is flowing in the trigger coil 5 or not and authorizes opening of the pair 6 of trigger contacts only if there is no current flowing. The current surveillance device 8 may include, for example, an auxiliary relay 8.1 and a switch 8.2 with flexible blades 8.6. The auxiliary relay 8.1 has its coil 8.3 connected in series with the pair 6 of trigger contacts and its pair of contacts 8.4 connected in series with the coil 8.5 of the switch 8.2 with flexible blades, the pair 4 of signaling contacts, and the trigger coil 5. The coil 8.5 of the switch 8.2 with flexible blades is wired in series with the pair 6 of trigger contacts. The current flowing through the coil 8.5 causes the switch 8.2 with flexible blades 8.6 to close. This closure leads to self-energization of the coil 8.3, and so the pair of contacts 8.4 of the auxiliary relay 8.1 are not opened.

The drawback of this configuration is again its cost and the degraded reliability of the protection device.

### SUMMARY OF THE INVENTION

The present invention relates to a protection device to be associated with a device for breaking a current flowing in an electrical circuit, the current-breaker device including at least one pair of trigger contacts and having an increased service life.

The invention also relates to a protection device of the above kind in which the risk of damage is low and of cost that is also low, compared to the prior art solution that entails adding components. The invention further relates to a protection device of the above kind of reliability that is improved relative to the prior art solution that entails adding components.

To achieve this, the present invention proposes, in the event of a fault, to provide a time-delay for detecting failure of the current-breaker device and, if the fault persists at the end of the time-delay, to prevent opening of the pair of trigger contacts pending operator intervention. This time-delay is independent of the implementation of means for actuating an upstream breaking and protection device, but it is used for its action on the trigger contacts of the trigger coil for opening the protection device according to the invention.

To be more precise, the present invention provides a protection device to be associated with a current-breaker device in an electrical circuit, this current-breaker device including at least one pair of electrical contacts; in particular, the electrical circuit comprises a trigger coil in series with contacts intended to break the current in said coil when the circuit breaker is opened. The protection device includes a measuring device for detecting a fault in the electrical circuit, at least one pair of trigger contacts adapted to assume a closed position or an open position and to energize a trigger coil adapted to operate the pair of contacts of the current-breaker device and a control device which commands the pair of trigger contacts depending on a signal from the measuring device. The control device commands launching of a time-delay by the time-delay means and closing of the pair of trigger contacts in the event of detection of a fault by the measuring device at the end of the time-delay, in the event of disappearance of the fault detected by the measuring device, opening of the pair of trigger contacts, at the end of the time-delay, in the event of the fault persisting detected by the measuring device, barring of opening pending intervention by an operator, the time-delay being sufficiently long for the pair of contacts of the current-breaker device to have had time to open before it ends and beginning sufficiently soon for the pair of contacts of the current-breaker device not to have had time to open when it is launched, if the current-breaker device is operational.

A typical value of the time-delay lies in the range approximately 100 ms to 150 ms.

Launching the time-delay and commanding closing of the pair of trigger contacts is substantially simultaneous.

The present invention also provides a method of protecting at least one pair of trigger contacts of a protection device to be associated with a current-breaker device in an electrical circuit, this current-breaker device including at least one pair of contacts, the method including a step of detecting a fault in the electrical circuit, a step of closing the pair of trigger contacts adapted to energize a trigger coil adapted to operate the pair of contacts of the current-breaker device to open it. It includes further
a step of launching a time-delay,
a step of detecting a fault in the electrical circuit, at the end of the time-delay, and
a step of opening the pair of trigger contacts if the fault has disappeared,
a step of barring opening of the pair of trigger contacts, if the fault persists,
the step of barring opening continuing pending operator intervention, the time-delay beginning sufficiently soon for the pair of contacts of the current-breaker device not to have had the time to open when it is launched and being sufficiently long for the pair of contacts of the current-breaker device to have had the time to open before its end, if the current-breaker device is operational.

The step of opening the pair of trigger contacts may be executed only if the fault has disappeared at the end of the time-delay

Alternatively, the step of opening the pair of trigger contacts may executed if the fault disappears while the time-delay is still running.

It is preferable for the step of launching the time-delay and the step of closing the pair of trigger contacts to be substantially simultaneous. The time-delay is provided so that the presence or absence of a fault can be verified after the current-breaker device has received a command to open.

### BRIEF DESCRIPTION OF THE DRAWINGS

The present invention can be better understood after reading the following description of embodiments of the invention given by way of illustrative and non-limiting example and with reference to the appended drawings, in which:

FIG. 1 (described above) shows diagrammatically a prior art device for protecting a current-breaker device;

FIGS. 2A, 2B (described above) show, in the form of timing diagrams relating to the prior art, the status of the measurement device, the pair of trigger contacts of a protection device, the pair of signaling contacts, and the pair of contacts of a current-breaker device when the current-breaker device is respectively operative and inoperative;

FIG. 2C (described above) is a flowchart illustrating the steps of the operation of a prior art protection device;

FIGS. 3A, 3B (described above) are diagrammatic representations of a prior art protection device including additional components connected to the pair of trigger contacts;

FIGS. 4A, 4B are two variants of a flowchart illustrating the method of the invention of protecting a device for protecting a current-breaker device;

FIG. 4C shows diagrammatically a device of the invention for protecting a current-breaker device;

FIGS. 4D and 4E show, in the form of flowcharts relating to the invention, the status of the measurement device, the pair of trigger contacts of a protection device, the pair of signaling contacts, and the pair of contacts of a current-breaker device when the current-breaker device is respectively operative and inoperative.

Well-known structures are not shown in detail in order not to burden the following description to no purpose.

### DETAILED DESCRIPTION OF PARTICULAR EMBODIMENTS

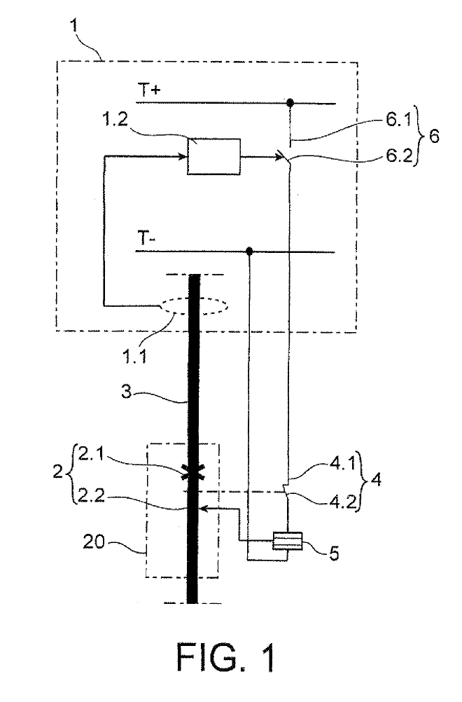

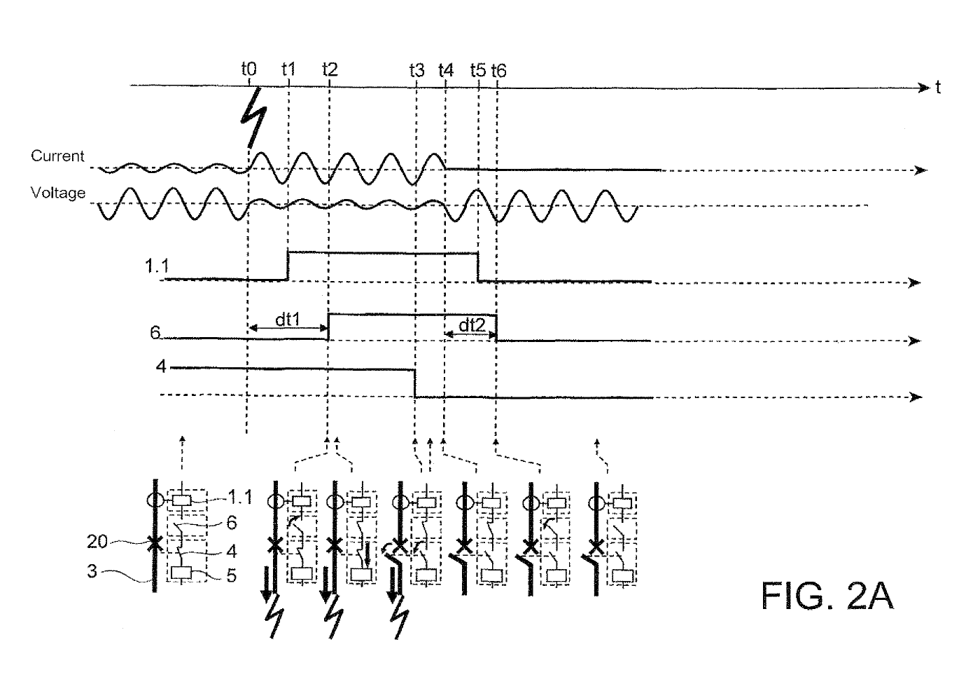

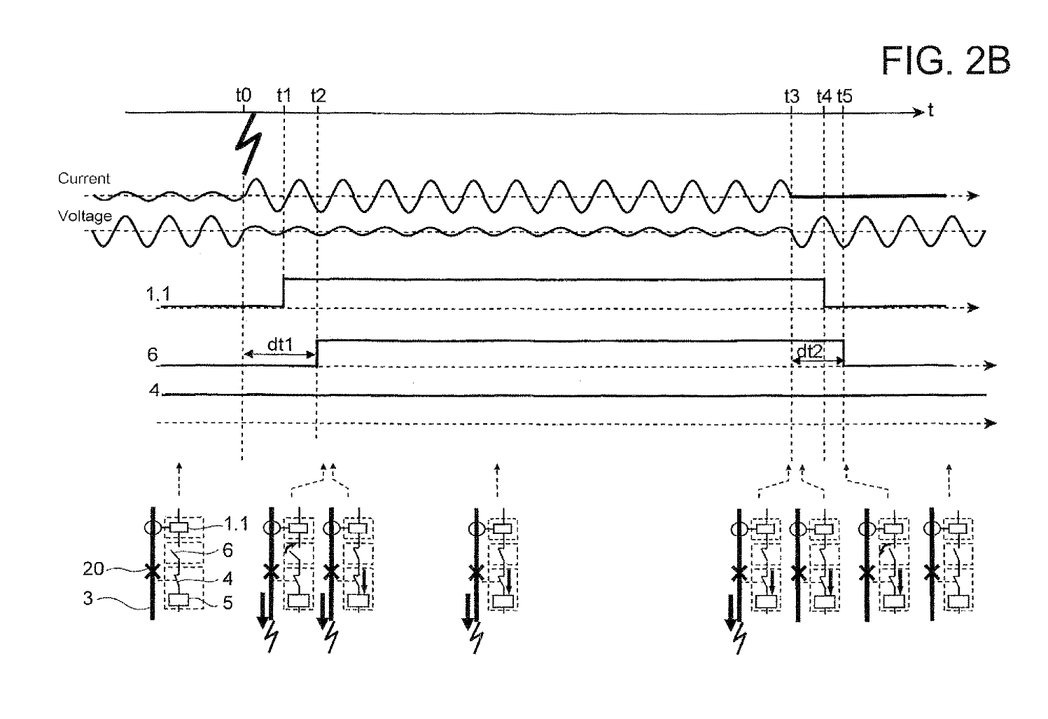

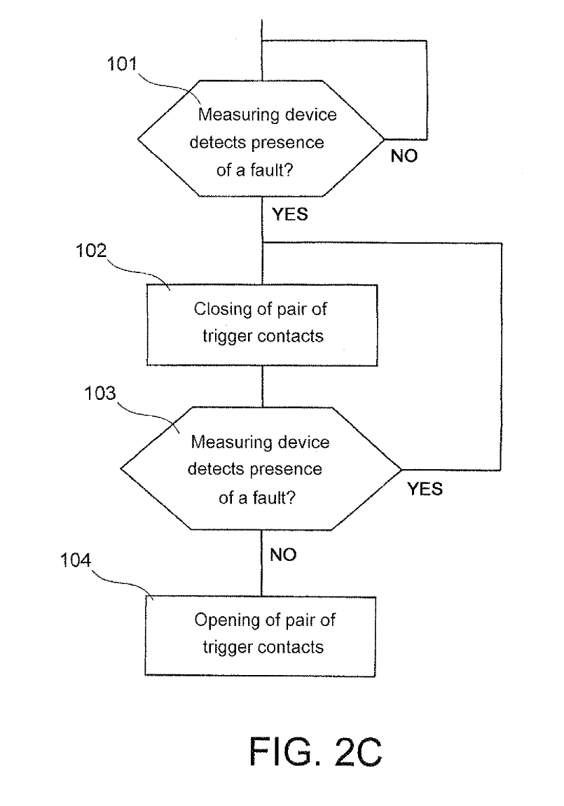

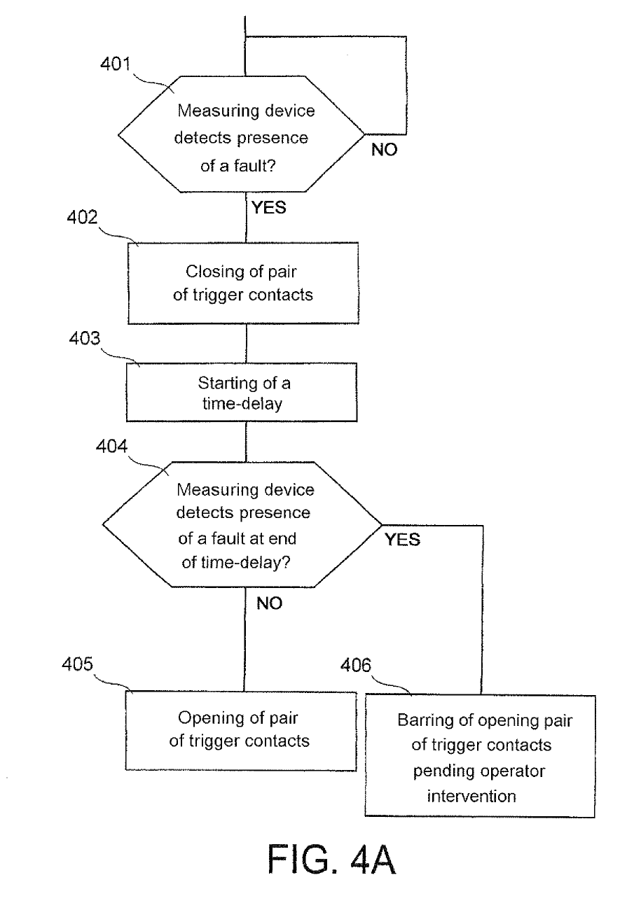

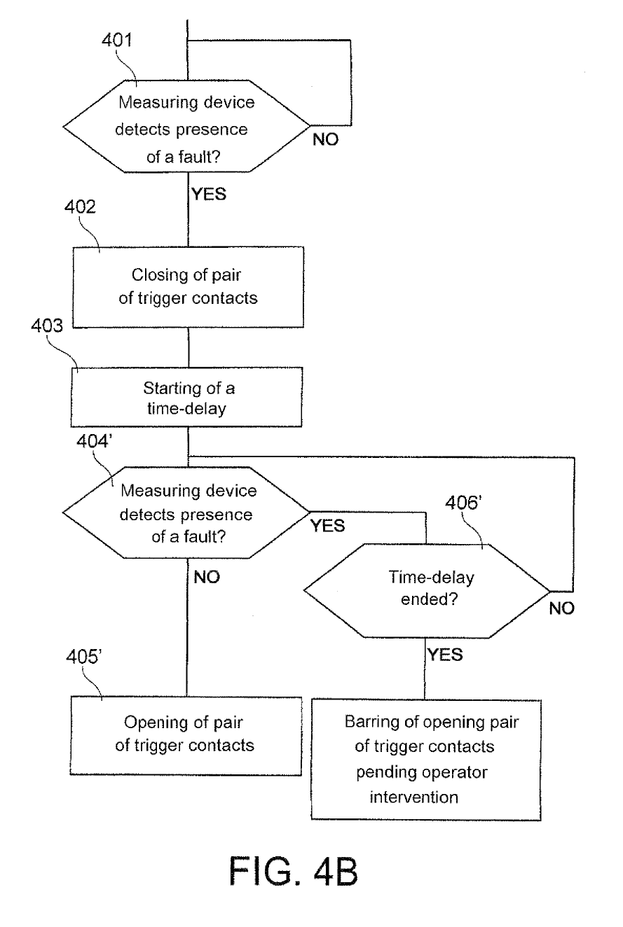

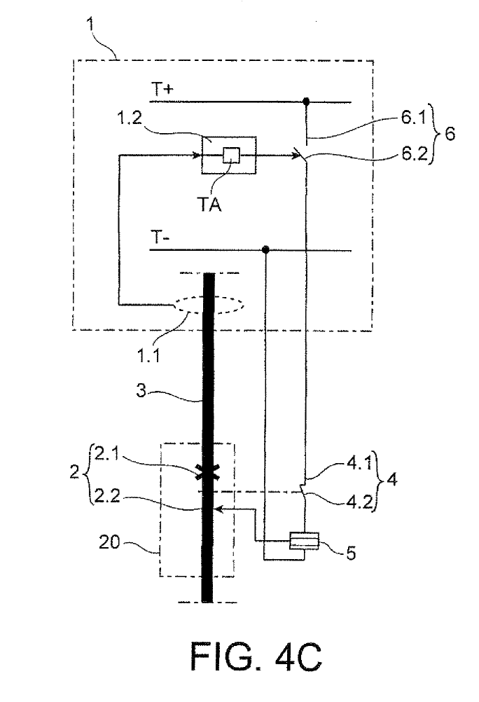

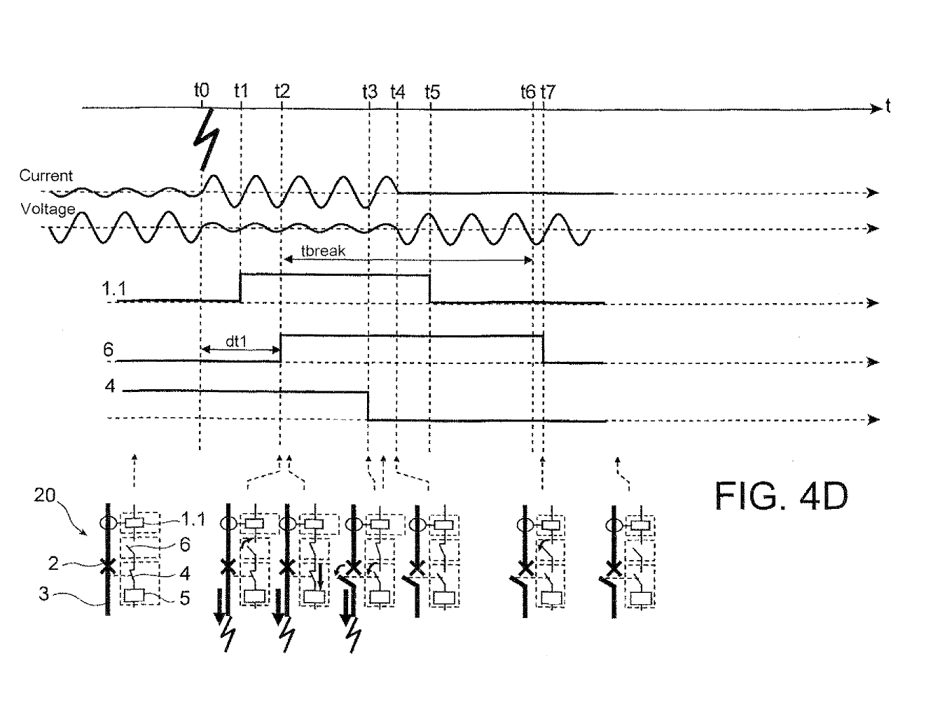

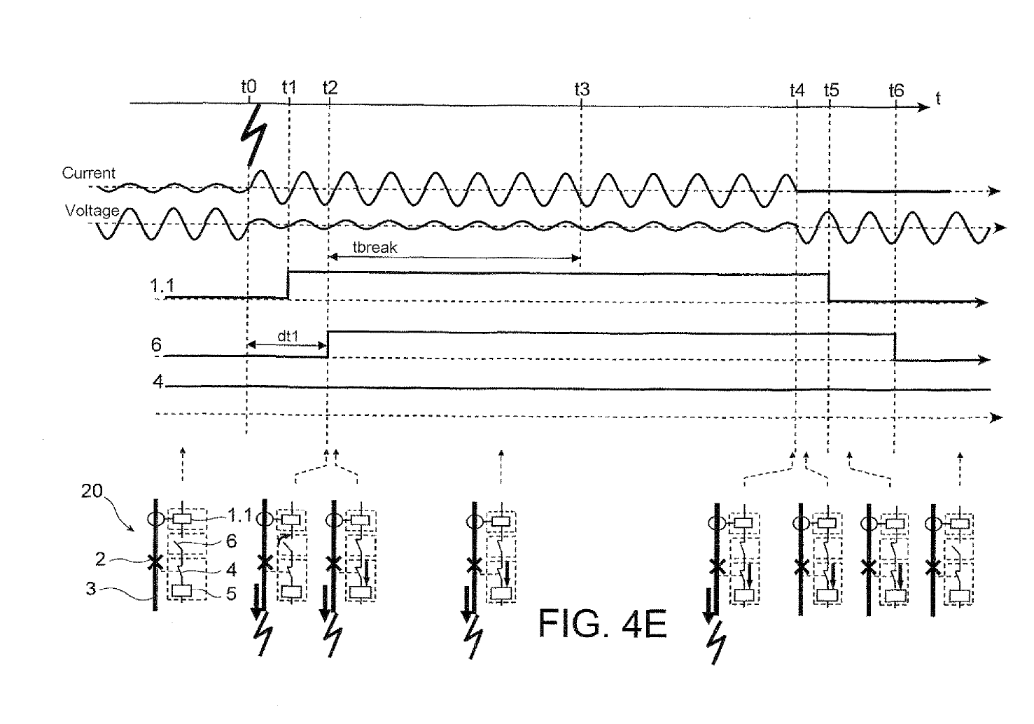

FIG. 4C shows diagrammatically the protection device of the invention associated with a current-breaker device. FIGS. 4A and 4B are two variants of a flowchart relating to the method of the invention of protecting at least one pair of trigger contacts. The protection device is similar to that from FIG. 1, and may comprises the means disclosed in EP 0 820 081 document; on the other hand, for the protection of the trigger contacts of the coil, there is no provision for adding components between the pair of trigger contacts and the trigger coil and the pair of signaling contacts. The only difference is in the device 1.2 for controlling the position of the pair 6 of trigger contacts, which now includes time-delay means and is able to launch the time-delay TA. This control device 1.2 controls the pair of trigger contacts depending on a signal from the measuring device of the protection device. It conventionally includes an electronic circuit that provides the time-delay TA and a relay for controlling the pair of trigger contacts. As in the prior art, these control devices are based on microprocessors, which of course include clocks able to provide the time-delay, but other alternatives are possible.

The FIG. 4A flowchart begins with a block 401 in which the measurement device of the protection device detects a fault in the electrical circuit. If there is no fault, nothing happens and surveillance continues pending the appearance of a fault. The measurements are effected in the conventional way at the secondaries of voltage and/or current transformers (not shown) installed on conductors of the monitored electrical circuit 3. The control device 1.2 of the protection device 1 uses calculation programs to compare these values measured at a given time, after digitization, with reference values specific to the protected electrical circuit.

As soon as a current and/or voltage fault is detected and the triggering criteria are met, these criteria being for example simply an overcurrent or an overcurrent combined with a low voltage, the control device 1.2 of the protection device 1 commands closing of the pair 6 of trigger contacts of the protection device (block 402). A time-delay is then launched, preferably simultaneously with the command to close the pair 6 of trigger contacts (block 403). The protection device 1 knows the time at which it commands the closing of the pair of trigger contacts. In contrast, it does not know the time at which the pair of trigger contacts will actually close.

Alternatively, it may be envisaged that the time-delay begins a little later, after the command to close the pair of trigger contacts, or a little sooner, between detecting the fault and the command to close the pair 6 of trigger contacts.

In all circumstances, the time-delay begins before the pair of contacts of the current-breaker device have had time to open. This timing naturally applies to satisfactory operation of the current-breaker device. Thus the time-delay begins before the pair 4 of signaling contacts have actually been able to open.

Moreover, the time-delay has a sufficient duration so that, once it has ended, the pair 2 of contacts of the current-breaker device 20 have had sufficient time to open if the current-breaker device 20 is not faulty.

The time-delay is set with a comfortable margin to prevent it ending before the pair 2 of contacts of the current-breaker device 20 have opened sufficiently to break the current in the electrical circuit 3, in particular if the relative movement of the contacts 2.1, 2.2 is slow. In practice, the time-delay may have a duration lying in the range 100 ms to 150 ms if it is considered that, when the current-breaker device is operative, about 60 ms elapse after the closing of the pair of trigger contacts 6 before its pair of contacts open and the fault current is broken. The typical duration tbreak of the time-delay TA is given in the description of FIGS. 4D and 4E.

Closing the pair 6 of trigger contacts energizes the trigger coil 5 which opens the pair 2 of contacts of the current-breaker device 20 if said device is not faulty; opening the pair 2 of contacts of the breaker device 20 leads to opening of the pair 4 of signaling contacts.

In FIG. 4A, verification by the measurement device 1.1 of the protection device 1 of the presence or absence of a fault in the electrical circuit 3 occurs at the end of the time-delay TA (block 404). If the measurement device 1.1 has not detected a fault in the electrical circuit 3, the device 1.2 controlling the protection device 1 commands opening of the pair 6 of trigger contacts, which may be effected without risk of damaging the contacts 6.1, 6.2 because the pair 4 of signaling contacts have been opened, drived by opening of the pair 2 of contacts of the current-breaker device 20 when it is not faulty (block 405).

Alternatively, if in the block 404 the measurement device 1.1 still detects a fault in the electrical circuit 3, this means that the pair 2 of contacts of the current-breaker device 20 have not been opened. The current-breaker device 20 is faulty. The pair 4 of signaling contacts are therefore not opened either, because they are mechanically connected to the pair 2 of contacts of the current-breaker device 20. The control device 1.2 of the protection device 1 prohibits opening of the pair 6 of trigger contacts pending operator intervention (block 406). This barring of opening ensures that the contacts 6.1, 6.2 of the pair 6 of trigger contacts will not be damaged when they are immobilized in the closed position. An alarm may be actuated to alert an operator to the necessity for intervention. The operator must intervene for the pair of trigger contacts to return to a condition favorable to opening, i.e. without current flowing in the trigger coil 5 and thus in the pair 6 of trigger contacts. The operator commands this opening. The risk of damage will have disappeared as the pair 6 of trigger contacts will no longer be carrying current.

The flowchart of FIG. 4B is identical to that of FIG. 4A up to the block 403. Instead of verifying whether the fault persists at the end of the time-delay TA, this verification begins sooner, while the time-delay TA is still running (block 404′). If on such verification the fault has disappeared, the control device 1.2 of the protection device 1 commands opening of the pair 6 of trigger contacts, which may be effected without risk of damaging its contacts 6.1, 6.2 because the pair 4 of signaling contacts have been opened drived by the opening of the pair 2 of contacts of the current-breaker device 20, which is not faulty (block 405′). In contrast, if the measurement device 1.1 still detects a fault in the electrical circuit 3 in the block 404′, this means that the pair 2 of contacts of the current-breaker device 20 have not opened. The command device 1.2 verifies whether the time-delay TA has ended (block 406′). If the time-delay TA has not ended, the measurement device 1.1 continues its surveillance (block 404′). If the time-delay TA has ended, this means that the current-breaker device 20 is faulty. The control device 1.2 of the protection device 1 then blocks opening of the pair 6 of trigger contacts pending operator intervention (block 407′).

FIG. 4D shows in timing diagram form the status of the pair 6 of trigger contacts, the pair 4 of signaling contacts, and the pair 2 of contacts of the current-breaker device during satisfactory operation of the current-breaker device.

At time t0, a fault occurs in the electrical circuit downstream of the current-breaker device. The shapes of the current and voltage in the measurement device in the electrical circuit are indicated. A fault current appears but has not yet been detected by the protection device. At time t1, the measurement device of the protection device detects the fault. The control device of the protection device is activated and at time t2 the pair of trigger contacts are closed, energizing the trigger coil. In this example, the time-delay also begins at this time t2. It could begin sooner or later, as explained above. The trigger coil 5 is energized by the flow of current following closing of the pair 6 of trigger contacts. At time t3, the pair of contacts of the current-breaker device and the pair 4 of signaling contacts are opened. Opening the pair 4 of signaling contacts breaks the energization current flowing in the trigger coil 5. Its contacts 4.1, 4.2 are dimensioned for this purpose, i.e. to withstand the inevitable electrical arc that appears when the contacts open.

At time t4 the fault has disappeared, signifying that the current-breaker device 20 has broken the current in the electrical circuit 3.

At time t5 the measuring device of the protection device detects that the current has been broken in the electrical circuit 3 and that the fault has disappeared. However, the pair 6 of trigger contacts of the protection device cannot open before the end of the time-delay TA. It is at the end of the time-delay TA that the pair of trigger contacts are either actuated or not.

Time t6 marks the end of the time-delay TA. No fault is detected by the measuring device 1.1 as the current-breaker device 20 has broken the current in the electrical circuit 3. At time t7, the pair 6 of trigger contacts are opened. The pair 6 of trigger contacts may be opened because the control device was activated as soon as the disappearance of the fault before the end of the time-delay TA was detected, but this activation was without effect as the time-delay TA had not ended.

The trigger coil 5 is no longer energized because no current is flowing, having been broken at time t3 on opening of the pair 4 of signaling contacts. There is no risk of damaging the contacts 6.1, 6.2 of the pair 6 of trigger contacts.

In the variant shown in FIG. 4B, the pair 6 of trigger contacts are opened at time t5 if the measuring device of the protection device has detected that the current in the electrical circuit 3 has been broken and that the fault has disappeared.

In FIGS. 4D and 4E, tbreak is the duration of the time-delay TA.

Referring to FIG. 4D, the duration tbreak is typically adjusted to be greater than the sum of:
the time interval between energization of the trigger coil 5 and disappearance of the fault by means of opening of the pair 2 of contacts of the current device 20, i.e. t4-t2; this time interval is typically 60 ms;
the time interval between disappearance of the fault and acquisition of this information by the measuring device 1.1, i.e. t5-t4; this time interval is typically 40 ms;
a safety margin that is typically 40 ms.

The situation in FIG. 4E is that the current-breaker circuit 20 is faulty and its pair 2 of contacts cannot be opened to break the current in the electrical circuit 3.

The chaining of the operations is identical to that described above between times t0 and t2. The time-delay also begins at time t2. The pair 2 of contacts of the current-breaker device 20 are not opened at the time shown as t3 in FIG. 4C because the device is faulty. The pair 4 of signaling contacts are not opened either. Time t3 in FIG. 4D marks the end of the time-delay TA. The fault is still detected by the measuring device 1.1 of the protection device. The protection device then knows that the current-breaker device is faulty. In this situation, the fault is eliminated at time t4 by opening the contacts of another current-breaker device (not shown) upstream of the faulty current-breaker device, by example by a method according to EP 0 820 081. The measuring device 1.1 then no longer detects a fault in the electrical circuit 3. At time t5, although the measuring device 1.1 no longer detects a fault in the electrical circuit 3, the control device 1.2 is not active in the change of position of the pair 6 of trigger contacts. This pair of contacts remains locked in the closed position pending operator intervention. At time t6 an operator has intervened and the pair 6 of trigger contacts have opened and have not been damaged.

Before effecting this opening operation, the operator must ensure that the current in the trigger coil is broken, for example by disconnecting the supply or opening the current-breaker device manually.

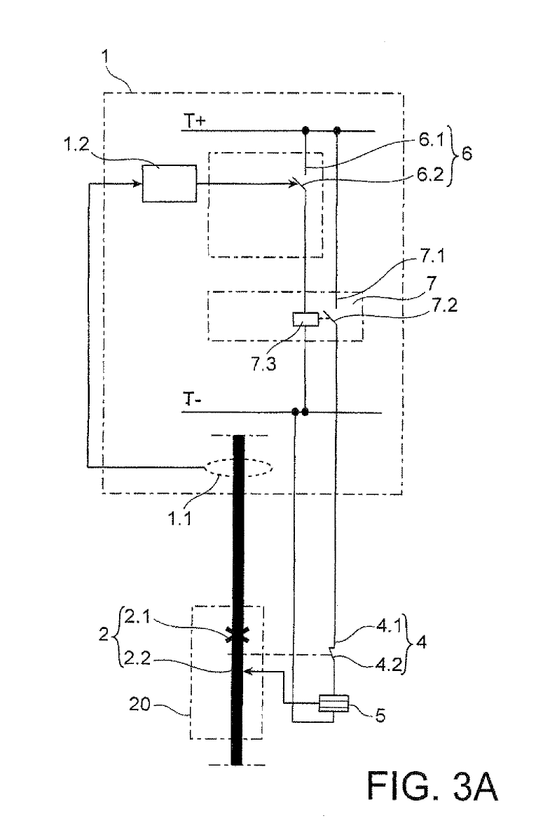

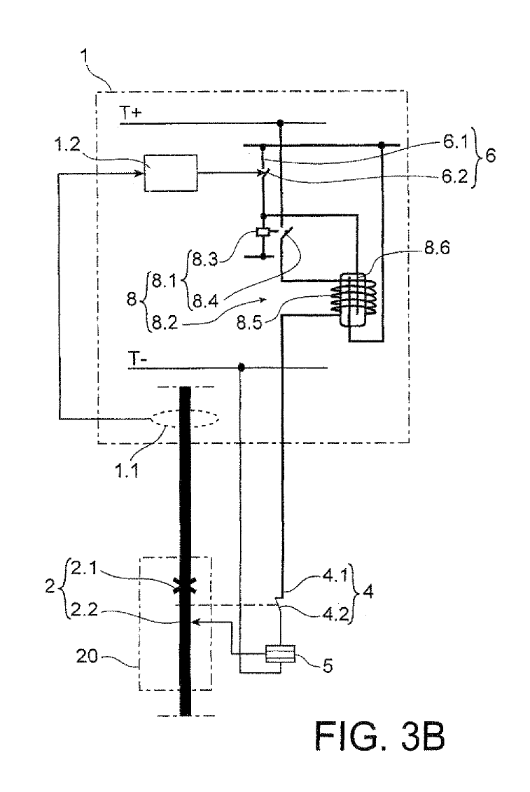

The protection device of the invention is reliable and does not introduce any additional hardware cost compared to known solutions such as those shown in FIGS. 3A, 3B. It suffices to provide the time-delay TA in the control device, this solution requiring only changes to the software.

1-8. (canceled)

9. A device for protecting a current-breaker device (20) to be associated with an electrical circuit (3), this current-breaker device (20) including at least one pair (2) of electrical contacts, including a measuring device (1.1) for detecting a fault in the electrical circuit, at least one pair (6) of trigger contacts adapted to assume a closed position or an open position and to energize a trigger coil (5) adapted to operate the pair (2) of contacts of the current-breaker device (20), and a control device (1.2) which commands the pair (6) of trigger contacts depending on a signal provided by the measuring device (1.1), time-delay (TA) means, characterized in that the control device (1.2) commands
in the event of the detection of a fault by the measuring device (1.1): launching of a time-delay by the time-delay (TA) means and closing the pair of trigger contacts (6);
at the end of the time-delay, in the event of disappearance of the fault detected by the measuring means: opening of the pair of trigger contacts; or
at the end of the time-delay, in the event of the fault persisting detected by the measuring means: barring of opening pending intervention by an operator;
the time-delay being sufficiently long and beginning sufficiently soon, for the pair of contacts (2) of the current-breaker device (20) to have had time to open before it ends and for the pair of contacts of the current-breaker device not to have had time to open when it is launched, if the current-breaker device is operational.

10. A device according to claim 9, wherein the time-delay has a duration lying in the range approximately 100 ms to approximately 150 ms.

11. A device according to claim 9, wherein the control device (1.2) launches the time-delay and commands closing of the pair (6) of trigger contacts substantially simultaneously.

12. A method of protecting at least one pair (6) of trigger contacts of a protection device (1) to be associated with a current-breaker device (20) in an electrical circuit (3), this current-breaker device (20) including at least one pair (2) of contacts, including a step of detecting a fault in the electrical circuit (3), a step of closing the pair (6) of trigger contact adapted to energize a trigger coil (5) adapted to operate the pair (2) of contacts of the current-breaker device (20) to open it, characterized in that it includes:
a step of launching a time-delay;
a step of detecting a fault in the electrical circuit at the end of the time-delay; and
a step of opening of the pair (6) of trigger contacts if the fault has disappeared or a step of barring opening of the pair (6) of trigger contacts if the fault persists, the step of barring opening continuing pending operator intervention,
the time-delay being sufficiently long and beginning sufficiently soon for the pair of contacts (2) of the current-breaker device (20) to have had the time to open before it ends and for the pair (2) of contacts of the current-breaker device not to have had the time to open when it is launched, if the current-breaker device (20) is operational.

13. A device according to claim 12, wherein the time-delay has a duration lying in the range approximately 100 ms to approximately 150 ms.

14. A device according to claim 12, wherein the control device launches the time-delay and commands closing of the pair (6) of trigger contacts substantially simultaneously.

15. A method according to claim 12, wherein the pair of trigger contacts are opened if the fault has disappeared at the end of the time-delay.

16. A method according to claim 12, wherein the pair of trigger contacts are opened if the fault disappears while the time-delay is still running.
